(19) United States
(12) Patent Application Publication
(10) Pub. No.: US 2009/0073042 A1
(43) Pub. Date: Mar. 19, 2009

(54) METHOD AND DEVICE FOR IMPROVED RADIO LINK PERFORMANCE

(75) Inventor: Wouter De Win, Zaventem (BE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/204,389

(22) Filed: Sep. 4, 2008

(30) Foreign Application Priority Data
Sep. 19, 2007 (GB) 0718237.1

(51) Int. Cl. G01S 5/02

(52) U.S. Cl. 342/450

(57) ABSTRACT

The present invention is related to a method for operating a mobile device comprising a navigation receiver and a communication terminal. The method comprises the steps of
obtaining by means of the navigation receiver information indicative of the reception conditions,
deriving from the information indicative of the reception conditions assistance data information for controlling operation of the communication terminal,
operating the communication terminal exploiting the assistance data information.

### FIELD OF THE INVENTION

The present invention relates to the field of mobile communication devices with multiple integrated functionalities and methods for operating such devices.

### STATE OF THE ART

Currently deployed mobile communication networks, such as GSM, WCDMA and CDMA2000, rely on the cellular principle to cover a wide area and at the same time provide sufficient radio access network capacity. Such a cellular network consists of many geographically spread base stations, each dedicated to covering a part of the total coverage area, also called a cell or sector. To guarantee service continuity when a mobile terminal is moving, cells generally overlap each other. The extent of this overlap can widely vary depending on local propagation conditions. Mobile stations located within these cell overlap zones have to choose to which base station they connect. In a more advanced operation mode, also known as soft handover, such a mobile station maintains a connection with more than one base station at the same time, thereby providing link diversity which yields an improved overall connection performance.

However, link performance between the different available connections could differ. To optimize radio access network capacity, it is important that the most performing connections be chosen. Typically, mobile stations can estimate the expected link performance based on measurements carried out on dedicated downlink channels provided by all base stations. These measurements need to be done on a regular basis and hence consume a certain amount of processing power. The measurements are also subject to noise and interference, so a deviation from the optimal solution can occur.

### AIMS OF THE INVENTION

The present invention aims to provide a method for enhancing the radio link performance of a combined mobile device comprising a navigation receiver and a communication terminal. It further aims to provide a mobile device suitable for carrying out the method.

### SUMMARY OF THE INVENTION

The present invention relates to a method for operating a mobile device comprising a navigation receiver and a communication terminal. The method comprises the steps of
obtaining by means of the navigation receiver information indicative of the reception conditions,
deriving from the information indicative of the reception conditions assistance data information for controlling operation of the communication terminal,
operating the communication terminal exploiting the assistance data information.

In an advantageous embodiment the step of operating the communication terminal further exploits propagation information directly obtained by the communication terminal.

Preferably the step of deriving comprises expressing the information in function of azimuth and elevation from the position of the communication terminal.

In another embodiment the step of deriving comprises a step of applying the information indicative of the reception conditions to an interpretation algorithm.

In another embodiment the method comprises the further step of regularly updating said information indicative of the reception conditions.

The information indicative of the reception conditions typically comprises at least one parameter of the group of parameters comprising {receive power, Doppler shift, multipath fading characteristics}.

The assistance data are preferably used for controlling any of the functions acquisition and tracking, hard handover, soft handover or beam steering.

In an advantageous embodiment the method further comprises the step of simultaneously operating the navigation receiver for navigation purposes.

In a second aspect the invention relates to a mobile device comprising a navigation receiver and a communication terminal. The mobile device also comprises an interface device arranged for receiving and processing information from the navigation receiver indicative of the conditions for receiving signals and for providing assistance data information derived from the received information to the communication terminal.

The interface device advantageously comprises storage means for storing the received information. The interface device preferably further comprises a processor for processing the received information into assistance data information.

### SHORT DESCRIPTION OF THE DRAWINGS

FIG. 1 represents a scheme of the method of the invention.

FIG. 2 represents a first exemplary scenario wherein the method of the invention can be applied.

FIG. 3 represents a second exemplary scenario wherein the method of the invention can be applied.

FIG. 4 represents a third exemplary scenario wherein the method of the invention can be applied.

FIG. 5 represents a block scheme of a mobile device according to the invention.

### DETAILED DESCRIPTION OF THE INVENTION

A current trend in the mobile communication field is the integration of multiple functionalities within one mobile device. One example is the coexistence of a GNSS (Global Navigation Satellite System) receiver (e.g. GPS and/or Galileo) together with a wireless communication terminal in a mobile handset. The present invention exploits opportunities for co-operation provided by such a combined device.

The invention proposes to reuse existing information obtained by the GNSS receiver to speed-up and improve controlling functions within the communication device such as signal acquisition and tracking control, hard and soft handover control and beam steering control.

Both navigation systems and wireless telecommunication systems rely on radio propagation with very similar spectral characteristics. In a GNSS system the transmitter is located within a satellite and hence, propagation effects such as shadowing and multipath fading are introduced by structures in the direct vicinity of the mobile terminal. On the other hand, wireless communication systems often make use of rooftop mounted base stations so that here too, a large amount of the propagation effects are caused by structures in the direct vicinity of the mobile terminal. Therefore, some degree of correlation exists between the characteristics of GNSS and communication signals that have similar reception angles. Because both the GNSS receiver and the communication terminal have to estimate the signal propagation conditions to be able to perform various operations, there is an opportunity for a performance improvement when the obtained propagation information can be shared between the two subdevices of the mobile device, i.e. between the GNSS receiver and the communication terminal.

During its normal operation a GNSS receiver obtains a set of reception parameters such as receive power, Doppler shift, multipath fading, etc . . . for every satellite signal that is received with sufficient signal-to-noise power ratio. As every GNSS satellite is transmitting a signal with very similar properties, these reception parameters can be tagged with a unique azimuth and elevation reception angle. As the GNSS satellites are more or less evenly spread around the hemisphere, the set of parameters can be used to construct a 3-dimensional polar map of propagation parameters. Such a polar map could be implemented as a table of propagation parameter values in function of the corresponding GNSS satellite azimuth and elevation angle at the observation instance. This 3-dimensional polar map essentially represents a sampled version of the propagation conditions in the vicinity of the mobile terminal location. Because generally propagation conditions change over time, this 3-dimensional polar map needs regular update. The obtained propagation parameters can via an assistance control algorithm be used to assist in various functions performed by the communication receiver such as signal acquisition and tracking control, hard and soft handover control and beam steering control. The task of the assistance control algorithm is to analyse the 3-dimensional polar map with propagation parameters, compare this with the stored base station location information and derive for instance which of the base stations are likely to be within line-of-sight of the mobile terminal.

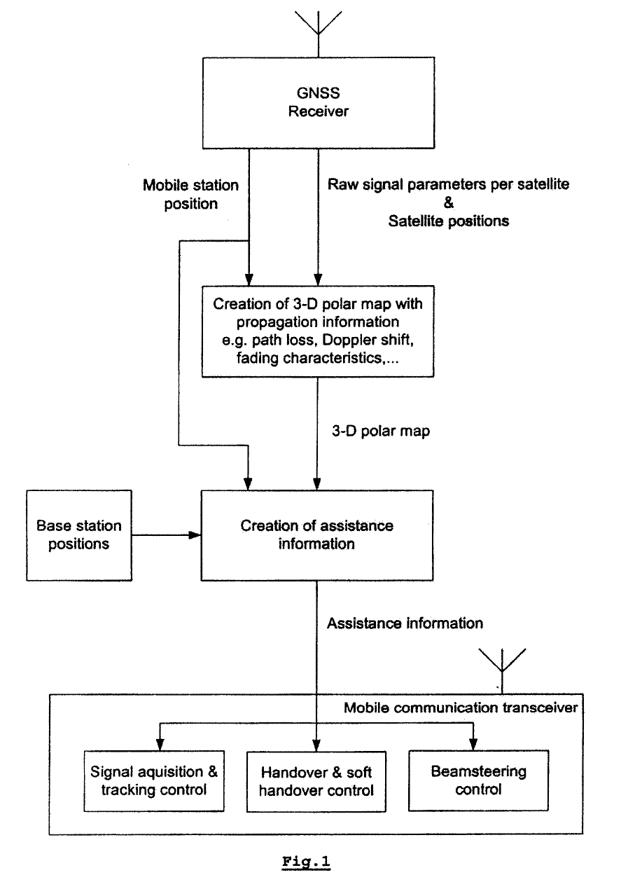

FIG. 1 shows the steps needed to implement the method of the invention.

Next to the mobile device position, the GNSS receiver also provides raw signal information for every satellite within view, as well as the actual satellite positions. This information is known by every GNSS receiver in operation, and hence there is no need for extra functionality other than making them available for external use, nor is there an impact on the power consumption. At the same time, the GNSS receiver can still be used for any navigation or positioning application running separately from the communication function.
The raw signal information, together with the mobile station and satellite positions, is provided to a mathematical function that projects it onto a 3-dimensional polar reference system. As such, a set of propagation parameters in function of azimuth and elevation seen from the mobile device position is composed. This 3-dimensional polar map gives a structured description of the propagation environment around the mobile device. It should be regularly updated to handle a changing propagation environment due to e.g. mobility of the mobile device.
The 3-dimensional polar map with propagation information is then provided to an assistance control algorithm that transforms it into assistance information that can be directly used by the various controlling functions within the mobile communication receiver. These are for instance the signal acquisition and tracking control, hard and soft handover control and beam steering control. The assistance information is used in co-operation with propagation information obtained by the communication receiver itself so that the controlling operations become faster and more accurate.

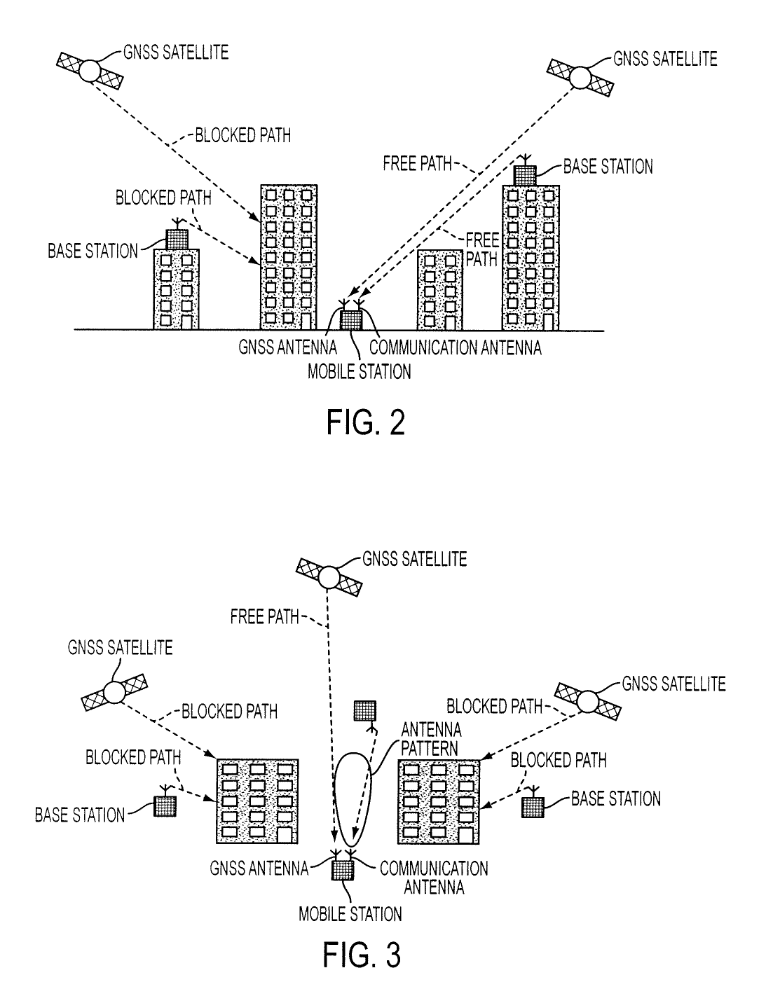

FIG. 2 gives an example of a mobile station in the vicinity of two base stations where the direct path to one of the base stations is blocked. This is also true for the satellite signals and hence, the GNSS receiver is able to inform the communication receiver about the existence and location of this blocked path. The communication receiver can use this information by e.g. avoiding spending time and power in searching for an ‘invisible’ base station and directly connect to a ‘visible’ one.

FIG. 3 gives an example of a mobile station that is focusing his antenna beam towards a visible base station while to other base stations are shadowed by buildings. Again, this information about the environment can be obtained from the co-operation process.

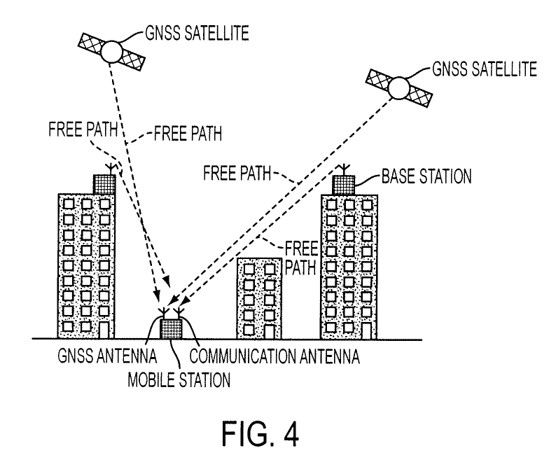

FIG. 4 gives an example of a mobile station in soft handover mode, where it is connected to more than one base station at the same time. Here also, the information obtained from the GNSS receiver can assist the communication receiver to be aware of this opportunity.

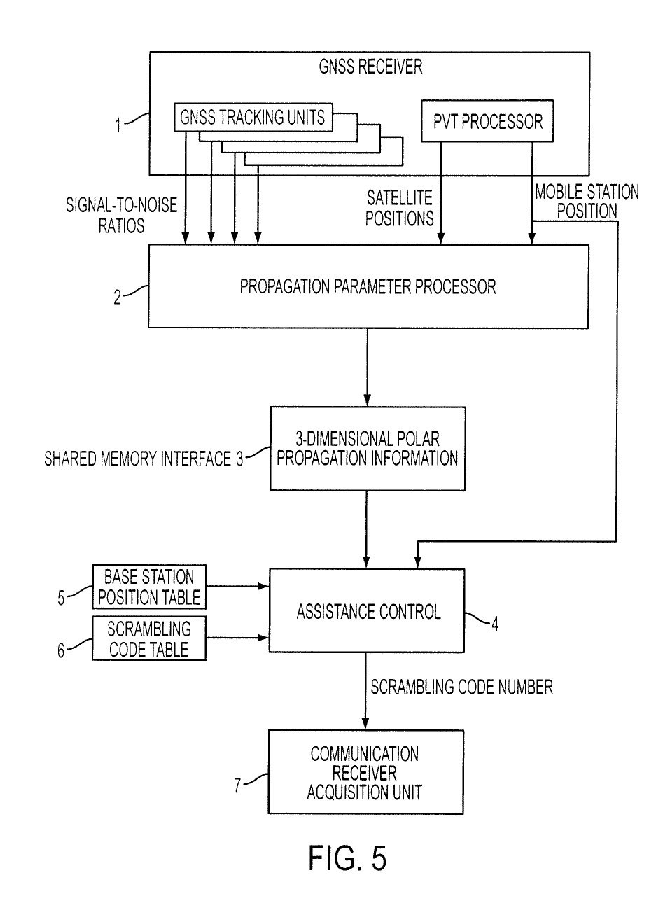

FIG. 5 gives an example implementation of a device operable according to the present invention. For simplicity, only the use of signal-to-noise ratio (SNR) provided by the GNSS tracking units is demonstrated. However, a similar setup can be used for any other parameter provided by the GNSS tracking units. Only functional blocks involved in the assistance process are shown. Blocks 1 and 7 are functions already present in a standard GNSS receiver or communication transceiver. Blocks 2, 3, 4, 5 and 6 are extra blocks required for implementing the assistance process. In this particular implementation the GNSS tracking units within the GNSS receiver (block 1 in FIG. 5) provide the measured signal-to-noise ratio for every satellite link that is received at a predefined update rate. In parallel with this information, the positions of all the satellites in the constellation, as well as the actual mobile station position are provided at the same update rate. This information is already available for internal operation of the GNSS receiver and should only be made available for external use. To be able to share propagation information between the GNSS receiver and the communication terminal, a shared memory (3) (FIG. 5) is introduced that contains 3-dimensional propagation information in polar format. In this example, the memory contains path loss values in function of a discrete set of vertical and horizontal reception angles. In another embodiment the memory can contain any parameter or any set of multiple parameters representing relevant information about the reception conditions. The memory is continuously updated by a propagation parameter processor function (2). The task of this function is to reformat the information provided by the GNSS receiver in the polar form used as an interface between the GNSS receiver and the mobile communication transceiver. This involves some trigonometric calculations to derive the reception angles. These calculations can for example be efficiently implemented by means of a digital signal processor, a field programmable gate array or in embedded software. In another embodiment the propagation parameter processor could generate other parameters and even multiple parameters in parallel. The shared memory is read repetitively by the assistance control algorithm (4) that compares this information with the base station positions and the mobile station position to decide on which base station has potentially the best propagation conditions. Also this function can efficiently be implemented, for example, by means of a digital signal processor, a field programmable gate array or in embedded software. The final information provided to the acquisition unit (7) of the communication transceiver, is one or more scrambling code numbers that correspond to the chosen base stations. As such, the acquisition unit can shorten its search for a usable base station and start its acquisition procedure with the advised scrambling code. In another embodiment of the invention the assistance control algorithm generates multiple assistance parameters in parallel and even support multiple functions within the communication terminal.

1. Method for operating a mobile device comprising a navigation receiver and a communication terminal, the method comprising:
obtaining by means of said navigation receiver information indicative of the reception Conditions;
deriving from said information indicative of the reception conditions assistance data information for controlling operation of said communication terminal; and
operating said communication terminal exploiting said assistance data information.

2. Method for operating a mobile device as in claim 1, whereby operating said communication terminal further exploits propagation information directly obtained by said communication terminal.

3. Method for operating a mobile device as in claim 1, wherein deriving from said information indicative of the reception conditions assistance data information for controlling operation of said communication terminal comprises expressing said information in function of azimuth and elevation from the position of said communication terminal.

4. Method for operating a mobile device as in claim 1, wherein deriving from said information indicative of the reception conditions assistance data information for controlling operation of said communication terminal comprises applying said information indicative of the reception conditions to an interpretation algorithm.

5. Method for operating a mobile device as in claim 1, further comprising updating said information indicative of the reception conditions.

6. Method for operating a mobile device as in claim 1, wherein said information indicative of the reception conditions comprises at least one parameter of the group of parameters comprising receive power, Doppler shift, multipath fading characteristics.

7. Method for operating a mobile device as in claim 1, wherein said assistance data are used for controlling any of the functions of acquisition and tracking, hard handover, soft handover or beam steering.

8. Method for operating a mobile device as in claim 1, further comprising simultaneously operating said navigation receiver for navigation purposes.

9. Mobile device comprising a navigation receiver, a communication terminal and an interface device arranged for receiving and processing information from said navigation receiver indicative of the reception conditions and for providing assistance data information derived from said received information to said communication terminal.

10. Mobile device as in claim 9, wherein said interface device comprises storage means for storing said received information.

11. Mobile device as in claim 9, wherein said interface device further comprises a processor for processing said received information into assistance data information.
